(19) United States
(12) Patent Application Publication
(10) Pub. No.: US 2023/0415256 A1
(43) Pub. Date: Dec. 28, 2023

(54) SYSTEMS AND METHODS FOR CAPABILITY INDICATION IN A MODULAR WELDING SYSTEM

(71) Applicant: Illinois Tool Works Inc., Glenview, IL (US)

(72) Inventors: Daniel Jacob Mortensen, Black Creek, WI (US); Connor Uitenbroek, Appleton, WI (US); Kenneth Austin Stanzel, Appleton, WI (US); Caleb R. Krisher, Appleton, WI (US)

(21) Appl. No.: 18/337,133

(22) Filed: Jun. 19, 2023

Related U.S. Application Data
(60) Provisional application No. 63/355,139, filed on Jun. 24, 2022.

(51) Int. Cl. B23K 9/095; B23K 9/10

(52) U.S. Cl. CPC B23K 9/0956; B23K 9/1087; B23K 9/1062; B23K 9/1068

(57) ABSTRACT

Systems and methods for an example modular welding systems having one or more system capabilities based on components connected to the welding systems are provided. In some examples, a modular welding system includes one or more components, such as a welding power supply, one or more welding torches, a wire feeder, and/or an auxiliary device, each of which can be coupled to one or more of the other components

### CROSS REFERENCE TO RELATED APPLICATIONS

This application is a Non-Provisional patent application of U.S. Provisional Patent Application No. 63/355,139 entitled “Systems And Methods For Capability Indication In A Modular Welding System” filed Jun. 24, 2022, which is herein incorporated by reference in its entirety.

### BACKGROUND

In some welding applications, a welding wire feeder may be used to feed welding wire from a wire spool to a welding torch for a welding operation. In some welding operations, it may be desirable for welding wire feeders to be portable. Benefits of a portable wire feeder include being able to locate the wire feeder at a work area some distance from a power supply. However, as an operator moves the wire feeder around the work area, a control or display on the power supply may be out of reach, making selection and/or adjustment of welding controls difficult. Further, the operator may not have an understanding of the number or type of components connected to the power supply. In some welding operations, it may be desirable to employ a user interface to provide the operator with control or display of the capabilities of the welding system.

### SUMMARY

The present disclosure relates generally to welding systems and, more particularly, to modular welding systems configured to determine, enable, and/or present system capabilities on user interfaces, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example modular welding system employing a wire feeder, in accordance with aspects of this disclosure.

FIGS. 2A and 2B illustrate example welding system user interfaces, in accordance with aspects of this disclosure.

FIG. 3 illustrates an example flow chart to determine, enable, and/or present welding system capabilities, in accordance with aspects of this disclosure.

FIG. 4 shows an example wire feeder equipped with the welding system user interface of FIG. 2, in accordance with aspects of this disclosure.

The figures are not necessarily to scale. Where appropriate, similar or identical reference numbers are used to refer to similar or identical components.

### DETAILED DESCRIPTION

Disclosed are example modular welding systems having one or more system capabilities based on components connected to the welding systems. In some examples, a modular welding system includes one or more components, such as a welding power supply, one or more welding torches, a wire feeder, and/or an auxiliary device, each of which can be coupled to one or more of the other components.

One or more of the connected components includes a user interface and/or control circuitry. In particular, the user interface is configured to present the one or more system capabilities to an operator. To determine the system capabilities, the control circuitry is configured to one or more of receive information corresponding to one or more operating parameters from each of the welding power supply, the one or more torches, or the wire feeder, determine the one or more system capabilities based on the one or more operating parameters, and enable one or more circuits of the welding power supply, the one or more torches, or the wire feeder corresponding to the one or more system capabilities.

In some examples, a worksite may employ a large number of welding components, such as welding power supplies, wire feeders, torches, auxiliary systems, as a list of non-limiting examples. Each welding component may vary in age, capabilities, brand, etc.

The disclosed systems and methods are operable to provide the operator with an understanding of how the components of the assembled, modular system work together and what the resulting capabilities. Having such capabilities determined, enabled, and presented to the operator ensures the capabilities of the modular welding systems are known and available to the operators.

Advantageously, by employing the disclosed modular system, operators can save time in setting up a welding workspace due to their understanding of the system capabilities. As a result, the operator is enabled to decide the appropriate way to set an output of the modular system and/or save time in modular system trouble-shooting in the event of a system lacking expected or needed capabilities to complete a welding job.

Conventional welding systems have control panels and/or user interfaces mounted to the welding power supply, with the expectation that the operator will return to a front panel of the welding power supply to perform multiple tasks, including selection of a welding operation. However, by the very nature of welding, in particular during use of a portable wire feeder, the operator may move around the work area, being separated from the welding power supply by some distance, and may not have access to and/or be within sight of the front panel of the welding system.

Additionally or alternatively, by use of a remote and/or system with an automatic setting feature, the operator may not need to return to the welding power supply and/or wire feeder to perform many common tasks (e.g., adjust welding parameter settings, such as when switching between an arc welding process and a gouging process). Thus, the operator may desire to view and/or access a system controls from the user interface.

In disclosed examples, each component of a modular welding system (e.g., a welding power source, a wire feeder, a remote control, a welding torch, an auxiliary system, etc.) is connected to and/or operable to communicate with each other component and/or a common controller, to determine capabilities of each component and/or the capabilities of the system comprising the various components. For example, based on the connected components, the modular welding system can include capabilities one or more of voltage control welding, current control welding, wire feed speed adjustment, polarity adjustment, a welding type process (e.g., gas metal arc welding (GMAW), shielded metal arc welding (SMAW), flux-cored arc welding (FCAW), gas tungsten arc welding (GTAW)), and/or gouging as a list of non-limiting examples.

Once the capabilities are determined, the welding system is operable to present the capabilities on a user interface and/or enable circuitry to implement such capabilities.

In disclosed examples, components of the modular welding system share a communication protocol that allows them to function as a synchronized system. For instance, even as different components are added to the welding system, the capabilities of each component, and the resulting capabilities of the system, can be determined/updated and presented to the operator. Depending on the connected components, a variety of features and/or enhancements can be added to the welding system. However, such features and/or enhancements may not be forwards or backwards compatible with every other welding system component or arrangement of components. Moreover, addition of a first component may provide an enhancement to a second component, which may or may not provide a complementary enhancement to the first component.

The disclosed systems and methods eliminate confusion about what features or functions will exist in a system of modular components by indicating system capabilities to the operator.

Advantageously, the various components can be connected to different welding power supplies that have different capabilities (e.g., different output ratings, different models, etc.), and continue to operate as a system, with capabilities of the modular system being updated as components are added to the modular system.

In response to a new component added to the system and/or a determination of the modular system capabilities, the system can present available features and/or capabilities to the operator via a user interface or display.

In some examples, the capabilities can be presented and the process changes accessed and implemented on the wire feeder, but may additionally or alternatively be presented and accessed at any other connected component.

In disclosed examples, a modular welding system having one or more system capabilities, including a welding power supply; one or more welding torches; a wire feeder coupled to one or more of the welding power supply or the one or more welding torches; a user interface to present the one or more system capabilities; and control circuitry to: receive information corresponding to one or more operating parameters from each of the welding power supply, the one or more torches, or the wire feeder; determine the one or more system capabilities based on the one or more operating parameters; and enable one or more circuits of the welding power supply, the one or more torches, or the wire feeder corresponding to the one or more system capabilities.

In some examples, the control circuitry is further configured to control the user interface to present the determined one or more system capabilities.

In some examples, the user interface includes one or more user inputs for selecting the determined one or more system capabilities.

In some examples, the one or more operating parameters include one or more of an operating voltage range, an operating current range, a wire feed speed range, or presence of polarity reversing circuitry.

In some examples, the one or more system capabilities include one or more of voltage control welding, current control welding, wire feed speed adjustment, or polarity adjustment.

In some examples, one or more sensors are configured to measure one or more characteristics of the welding power supply, the one or more torches, the wire feeder, or the one or more weld cables.

In some examples, the one or more sensors are further configured to transmit the measured one or more characteristics to the control circuitry, the control circuitry further configured to calculate a system capability of the one or more system capabilities based on the measurements.

In some examples, the one or more sensors include circuitry to determine cable inductance of the one or more weld cables.

In some examples, the control circuitry or the user interface is located in the welding power supply.

In some examples, the control circuitry or the user interface is located in the wire feeder.

In some examples, the system includes one or more auxiliary devices, each auxiliary device including auxiliary control circuitry and communication circuitry to transmit information corresponding to one or more operating parameters to the auxiliary control circuitry. In examples, the one or more auxiliary devices includes a remote control device or an auxiliary power supply.

In some disclosed examples, a wire feeder coupled to one or more of a welding power supply or one or more welding torches, the wire feeder including a user interface to present one or more system capabilities; and control circuitry to: receive information corresponding to one or more operating parameters from each of the welding power supply or the one or more torches; determine the one or more system capabilities based on the one or more operating parameters; and control the user interface to present the determined one or more system capabilities.

In some examples, the control circuitry is further configured to enable one or more circuits of the welding power supply, the one or more torches, or the wire feeder corresponding to the one or more system capabilities.

In some examples, the user interface includes one or more user inputs for selecting the determined one or more system capabilities.

In some examples, the one or more system capabilities include a welding type process including one or more of gas metal arc (GMAW) welding, shielded metal arc (SMAW) welding, flux-cored arc (FCAW) welding, gas tungsten arc (GTAW) welding, or gouging.

In some disclosed examples, a user interface to present the one or more system capabilities, the user interface includes one or more switches to receive an input corresponding to one or more operating parameters from one or more of a welding power supply, one or more torches, or a wire feeder; and one or more dynamic displays or icons operable to display the one or more system capabilities corresponding to the one or more operating parameters.

In some examples, the user interface is incorporated into a wire feeder. In examples, the wire feeder comprises control circuitry operable to enable one or more circuits of the welding power supply, the one or more torches, or the wire feeder corresponding to the one or more system capabilities. In examples, the one or more operating parameters include one or more of an operating voltage range, an operating current range, a wire feed speed range, or presence of polarity reversing circuitry.

The term “welding system” or “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding power” or “welding-type power” refers to power suitable for welding, plasma cutting, induction heating, CAC-A and/or hot wire welding/preheating (including laser welding and laser cladding).

As used herein, the term “welding power supply,” “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW), shielded metal arc welding (SMAW), spray, short circuit, and/or any other type of welding process.

As used herein, the term “welding program” includes at least a set of welding parameters for controlling a weld. A welding program may further include other software, algorithms, processes, or other logic to control one or more welding-type devices to perform a weld.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, motion, automation, monitoring, air filtration, displays, and/or any other type of welding-related system.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

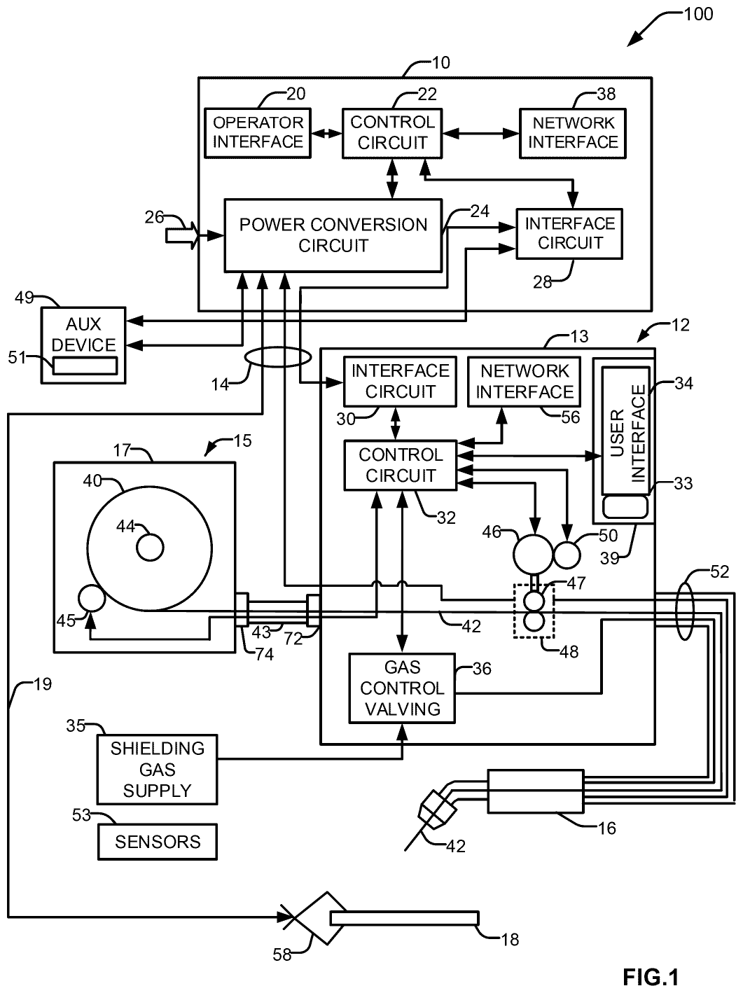

FIG. 1 illustrates an example modular welding system 100 for performing welding operations. As shown, the modular welding system 100 includes one or more components, such as a welding power supply 10 and a wire feeder 12 coupled via conductors or conduits 14. In the illustrated example, the power supply 10 is separate from the wire feeder 12, such that the wire feeder 12 may be positioned near a welding location at some distance from the power supply 10. Terminals are typically provided on the power supply 10 and on the wire feeder 12 to allow the conductors 14 or conduits to be coupled to the systems so as to allow for power and gas to be provided to the wire feeder 12 from the power supply 10, and to allow data to be exchanged between the two devices.

The modular welding system 100 is configured to provide wire from a welding wire source 15, power from the power supply 12, and shielding gas from a shielding gas supply 35, to a welding tool or torch 16. The torch 16 may be any type of arc welding torch, (e.g., GMAW, GTAW, FCAW, SMAW) and may allow for the feed of a welding wire 42 (e.g., an electrode wire) and gas to a location adjacent to a workpiece 18. A work cable 19 is run to the welding workpiece 18 so as to complete an electrical circuit between the power supply 10 and the workpiece 18. In additional or alternative examples, the torch 16 is a gouging torch.

The modular welding system 100 is configured for weld settings (e.g., weld parameters, such as voltage, wire feed speed, current, gas flow, inductance, physical weld parameters, advanced welding programs, pulse parameters, etc.) to be selected by the operator and/or a welding sequence, such as via an operator interface 20 provided on the power supply 10 and/or a user interface 34 of the wire feeder 12. The operator interface 20 will typically be incorporated into a front faceplate of the power supply 10, and may allow for selection of settings such as the weld process, the type of wire to be used, voltage and current settings, and so forth. In particular, the example modular welding system 100 is configured to allow for welding with various steels, aluminums, alloys, and/or other welding wire that is channeled through the torch 16. Further, the modular welding system 100 is configured to employ welding wires with a variety of wire sizes. These weld settings are communicated to a control circuit 22 within the power supply 10. The system may be particularly adapted to implement welding regimes configured for certain electrode types. The control circuit 22 operates to control generation of welding power output that is supplied to the welding wire 42 for carrying out the desired welding operation.

The torch 16 applies power from the power supply 10 to the wire electrode 42, typically by a welding cable 52. Similarly, shielding gas from a shielding gas supply 35 is fed through the wire feeder 12 and the welding cable 52. During welding operations, the welding wire 42 is advanced through a jacket of the welding cable 52 towards the torch 16.

The work cable 19 and clamp 58 allow for closing an electrical circuit from the power supply 10 through the welding torch 16, the electrode (wire) 42, and the workpiece 18 for maintaining the welding arc during the operation. Although illustrated with a single torch 16 connected to the wire feeder 12, in some examples multiple torches of a variety of types may be connected to the wire feeder 12. In examples, a gouging or cutting torch may be separately connected to the wire feeder 12 and/or the power supply 10.

The control circuit 22 is coupled to power conversion circuit 24. This power conversion circuit 24 is adapted to create the output power, such as pulsed waveforms applied to the welding wire 42 at the torch 16. Various power conversion circuits may be employed, including choppers, boost circuitry, buck circuitry, inverters, converters, and/or other switched mode power supply circuitry, and/or any other type of power conversion circuitry. The power conversion circuit 24 is coupled to a source of electrical power as indicated by arrow 26. The power applied to the power conversion circuit 24 may originate in the power grid, although other sources of power may also be used, such as power generated by an engine-driven generator, batteries, fuel cells or other alternative sources. The power supply 10 illustrated in FIG. 1 may also include an interface circuit 28 configured to allow the control circuit 22 to exchange signals with the wire feeder 12, an auxiliary device 49, and/or other components of the modular welding system 100. In some examples, the auxiliary device 49 includes circuitry 51, which may include control circuitry, power conversion circuitry, network and/or interface circuitry, and/or an operator interface, as disclosed herein.

The wire feeder 12 includes a complimentary interface circuit 30 that is coupled to the interface circuit 28. In some examples, multi-pin interfaces may be provided on both components and a multi-conductor cable run between the interface circuit to allow for such information as wire feed speeds, processes, selected currents, voltages or power levels, and so forth to be set on either the power supply 10, the wire feeder 12, or both. Additionally or alternatively, the interface circuit 30 and the interface circuit 28 may communicate wirelessly and/or via the weld cable 14.

The wire feeder 12 also includes control circuit 32 coupled to the interface circuit 30. As described below, the control circuit 32 allows for control of welding parameters, such as wire feed speeds, to be controlled in accordance with operator selections or stored sequence instructions, and permits these settings to be fed back to the power supply 10 via the interface circuit. The control circuit 32 is coupled to an user interface 34 on the wire feeder that allows selection of one or more welding parameters, particularly wire feed speed. The user interface 34 may also allow for selection of such weld parameters as the process, the type of wire utilized, current, voltage or power settings, and so forth.

In some examples, the wire feeder 12 includes one or more power conversion circuits, which may be similar to power conversion circuit 24. For instance, the power conversion circuits in the wire feeder 12 may include choppers, boost circuitry, buck circuitry, inverters, converters, and/or other switched mode power supply circuitry, and/or any other type of power conversion circuitry to control power output to the welding torch 16 and/or other type of welding tool, as well as one or more auxiliary outputs.

The control circuit 32 may also be coupled to gas control valving 36 which regulates and/or measures the flow of shielding gas from the shielding gas supply 35 to the torch 16. In general, such gas is provided at the time of welding, and may be turned on immediately preceding the weld and for a short time following the weld. The shielding gas supply 35 may be provided in the form of pressurized bottles.

The wire feeder 12 includes components for feeding wire to the welding torch 16 and thereby to the welding operation, under the control of control circuit 32. As illustrated, the drive components and control components of the wire feeder 12 are included within a first housing or enclosure 13. A spool of wire 40 is mounted on a spool hub 44 in a second housing or enclosure 17. The wire source 15 may be integrated with the wire feeder 12. In some examples, the wire source 15 is physically independent from the wire feeder 12. In other words, the wire source 15 is connectable to and disconnectable from the wire feeder 12, and the wire source 15 can be physically moved independently from the wire feeder 12.

In some examples, the spool hub 40 is configured to support up to a sixty-pound spool of wire and the enclosure 17 is large enough to enclose a sixty-pound spool of wire. An inlet 72 of the wire feeder 12 is connected to an outlet 74 of the wire source 15 via one or more connectors 43. In some examples, the wire feeder inlet 72 is directly connected to the wire source outlet 74. For example, the wire feeder inlet 72 may include a first connector that directly connects to a second connector of the wire source outlet 74. For example, the wire feeder inlet 72 may connect to the wire source outlet 74 via quick disconnect connectors or the like through which wire from the spool 40 may be fed. In some examples, a conduit may connect the wire feeder inlet 72 to the wire source outlet 74. In some examples, the conduit is flexible (e.g., similar to a weld cable). In some examples, the conduit may be a rigid conduit. The connectors 43 enable welding wire 42 from the spool 40 to be fed to the drive components of the wire feeder 12. The connectors 43 may also enable one or more control cables to be connected from components within the wire source enclosure 17 to the control circuit 32.

Welding wire 42 is unspooled from the spool 40 and is progressively fed to the torch 16. The spool 40 may be associated with a clutch 45 that disengages the spool 40 when wire is to be fed from the spool 40 to the torch 16. The clutch 45 may also be regulated, for example by the control circuit 32, to maintain a minimum friction level to avoid free spinning of the spool 40. The first wire feeder motor 46 may be provided within a housing 48 that engages with wire feed rollers 47 to push wire from the wire feeder 12 towards the torch 16.

In practice, at least one of the rollers 47 is mechanically coupled to the motor 46 and is rotated by the motor 46 to drive the wire from the wire feeder 12, while the mating roller is biased towards the wire to apply adequate pressure by the two rollers to the wire. Some systems may include multiple rollers of this type. In some examples, the wire feeder 12 is configured to feed ⅛ inch wire. In some examples, the wire feeder 12 is configured to feed 3/32 inch wire.

A tachometer 50 or other sensor may be provided for detecting the speed of the first wire feeder motor 46, the rollers 47, or any other associated component so as to provide an indication of the actual wire feed speed. Signals from the tachometer 50 are fed back to the control circuit 32 such that the control circuit 32 can track the length of wire that has been fed. The length of wire may be used directly to calculate consumption of the wire and/or the length may be converted to wire weight based on the type of wire and its diameter.

In some examples, the user interface 34 is configured to present one or more capabilities of the modular welding system 100 to the operator.

A display and/or controls within the user interface 34 may be adaptable to changes in arrangement of the modular welding system. Although illustrated with a single user interface 34, two or more user interfaces may be employed, each responsive to changes in system capabilities, as described herein. Further, although shown on a single surface (and in a single mount), multiple surfaces and/or mounts may be provided for the user interfaces on the wire feeder 12.

In some examples, the system 100 includes one or more sensors 53 to measure one or more characteristics of the welding power supply, the one or more torches, the wire feeder, or the one or more weld cables. For instance, the sensors may be integrated with a particular component and/or external to a given component. The sensors may be configured to directly measure a welding parameter (e.g., a voltage output) and/or indirectly measure a welding parameter (e.g., measuring current of motor 46 to determine wire feed speed).

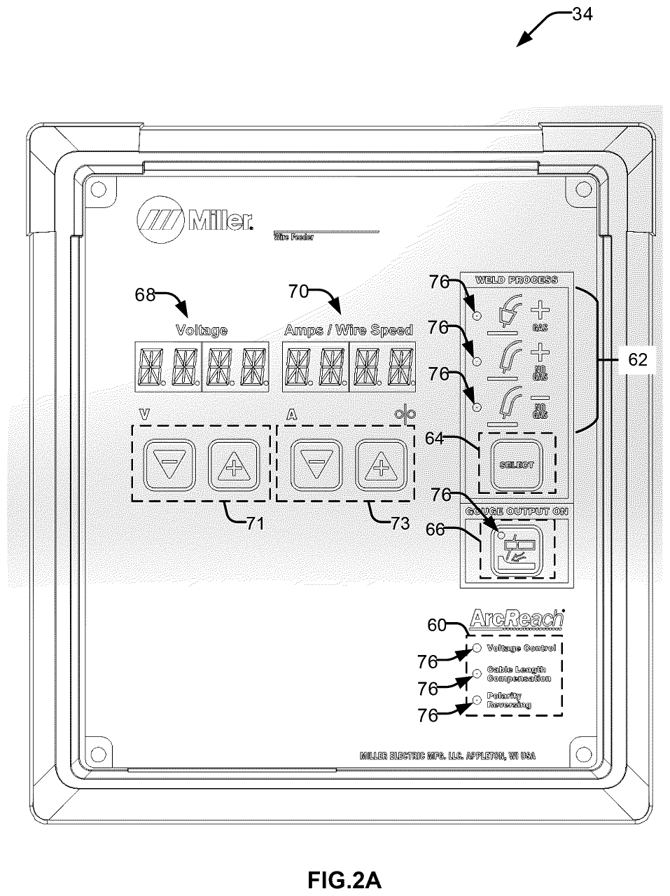

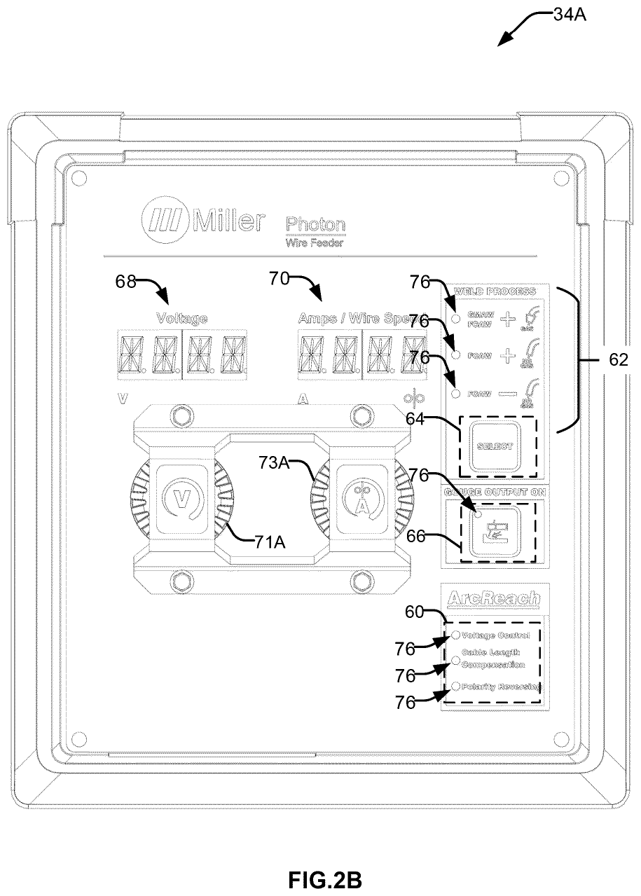

The sensors are configured to transmit the measured characteristics to the control circuitry (e.g., control circuitry 22. 32), the control circuitry to determine a system capability based on the measurements. For examples, the sensors may include circuitry to determine cable inductance of the one or more weld cables, which can be indicated on user interface 34. The cable inductance is often correlated to a length of a welding cable. As the system determines the length of the cable, an indicator can alert an operator that a determination is underway. This can be presented to the operator as a flashing icon (e.g., LED 76 of icon 60 in FIG. 2). Once the calculation is complete, the display can present the determination on the display. The indicator may present a status identifier for a cable compensation system as well.

FIG. 2A illustrates a detailed example of a welding system user interface, such as wire feeder interface 34. In some examples, the user interface 34 employs a configurable display (which may change position or orientation of displayed text, graphics and/or user inputs in response to a change in system components or component capabilities, etc.), one or more physical controls (e.g., knobs, switches, membrane switches, buttons, etc.), and/or touch screen enabled controls. In some examples, the user interface 34 includes a dynamically configurable display, such as a liquid crystal display (LCD) and/or a light-emitting diode (LED) display. As such, as system capabilities are introduced and/or removed due to changing the components of the modular welding system, icons, readouts, and/or user input devices may be added and/or removed accordingly.

The example user interface 34 provides multiple selector switches, including a welding process selector 64, a gouge output selector 66, voltage scrolling tabs 71, and/or current or wire feed speed scrolling buttons 73, as a list of non-limiting examples. Multiple dynamic displays are provided to present an indication of a welding process 62, an output value (e.g., voltage level 68, current level and/or wire feed speed 70, etc.), activation of a gouge output (associated with gouge output selector 66), and/or voltage control, cable length compensation, or polarity reversing on display icon 60. For example, the dynamic displays may illuminate, animate, change color, or otherwise indicate a particular capability and/or feature is available and/or enabled. In some examples, an associated icon can themselves illuminate (e.g., the torches corresponding to “+ gas”, “+ no gas”, or “− no gas”), and/or an associated icon (e.g., LED 76) can indicate a particular capability.

Thus, a change in type (e.g., power supply with polarity reversing capabilities) and/or disposition (e.g., available wire type or amount) of connected components may cause illumination or de-illumination of a corresponding icon. Accordingly, the user interface 34 may reconfigure the display to correspond to the new arrangement (such as automatically, in response to component recognition or communicated information, and/or from a user input).

FIG. 2B illustrates a detailed example of another welding system user interface 34A. The example user interface 34A provides multiple selector switches, many of which are similar to those presented on user interface 34 of FIG. 2A. In the example of FIG. 2B, however, includes nobs 71A and 73A, to control adjustment of voltage, and/or current or wire feed speed scrolling buttons, respectively. In some examples, the display and/or user inputs presented in FIGS. 2A and 2B are available on another component (e.g., a remote control, a power supply, a torch, etc.).

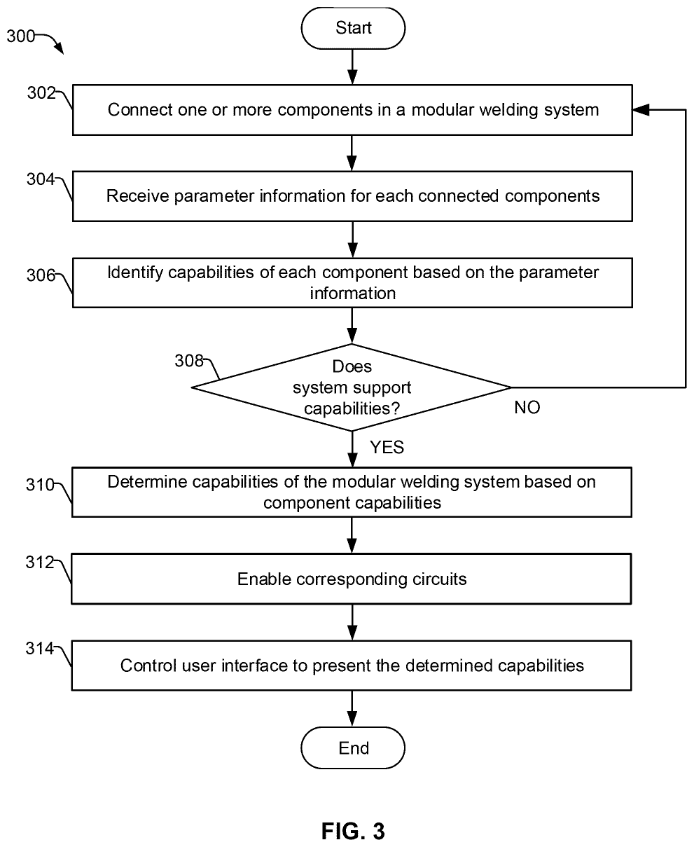

FIG. 3 is a flowchart representative of the program 300. For example, the program 300 may be stored on a memory (e.g., memory circuitry 156) linked to processor (e.g., processor 150) as a set of instructions to determine, enable, and/or present system capabilities of a modular welding system (e.g., system 100) on an operator and/or user interface (e.g., interface 20, 34) via associated circuitry (e.g., control circuitry 22, 32), as disclosed herein.

At block 302, connect one or more components (e.g., welding power supplies, welding torches, wire feeders, auxiliary devices, etc.) in a modular welding system.

At block 304, the program 300 receives information corresponding to one or more operating parameters from each component (e.g., the welding power supply, the torches, the wire feeder, etc.). In some examples, the operating parameter information reflects the manufacturers operating specifications (e.g., operating voltage range, an operating current range, a wire feed speed range), available output/input ranges (e.g., a charge level of an energy power source), particular circuitry within a component (e.g., polarity reversing circuitry), and/or component type (e.g., wire feeder), as a list of non-limiting examples.

At block 306, the program 300 identifies one or more capabilities of each component in the modular welding system, based on the one or more operating parameters.

At block 308, the program 300 the capabilities of the various components are compared with those of one or more of the other components to determine compatibility of the connected components. For example, a wire feeder or auxiliary device may include studs for a welding torch. However, if no gas delivery system is connected, the process would determine the system lacks the capability to perform a welding process requiring gas.

Thus, at block 310, the program 300 determines the one or more system capabilities based on the comparison and/or the one or more operating parameters via the control circuitry. For example, the one or more system capabilities may include one or more of available welding processes, voltage control welding, current control welding, wire feed speed adjustment, and/or polarity adjustment.

At block 312, the program 300 enables one or more circuits of the welding power supply, the one or more torches, and/or the wire feeder corresponding to the one or more system capabilities. For example, the control circuitry may enable a gouge torch connection in response to the determination that that polarity reversing circuitry is available and/or selected.

At block 314, the program 300 controls the user interface to present the determined one or more system capabilities via the control circuitry. This may include illuminating and/or animating one or more icons and/or text displayed on user interface 34, and/or configuring a dynamic LCD/LED display to create and present icons and/or text corresponding to the determined capabilities. Once the system capabilities are determined, enabled, and/or presented, the program 300 may end, continue in a loop, activate periodically and/or in response to a command to ensure system capabilities are current.

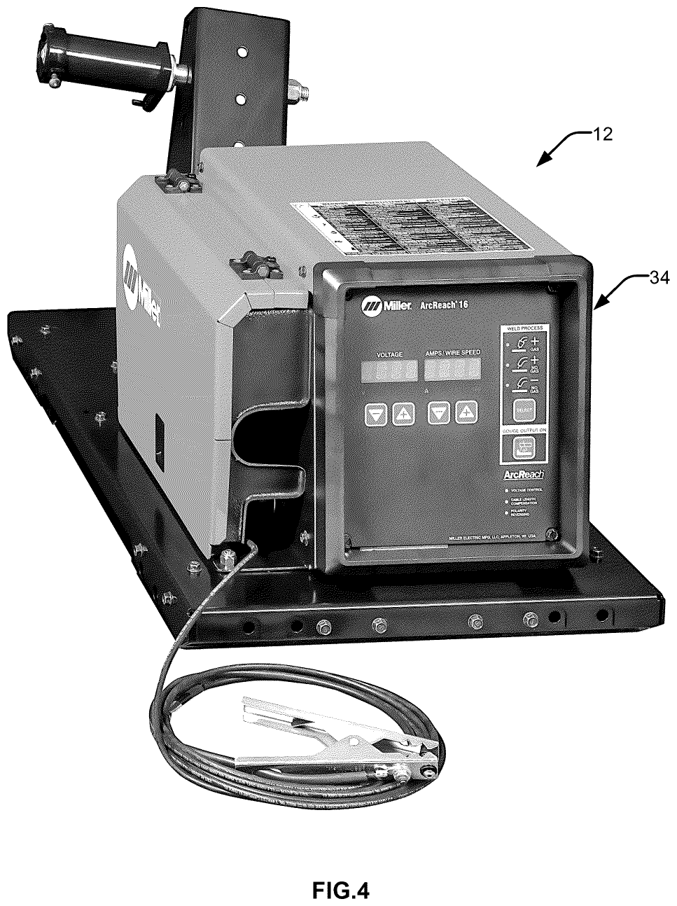

FIG. 4 shows an example wire feeder 121 equipped with sample user interface 34, as disclosed herein. As disclosed herein, employing the user interface 34 allows operators to adjust parameters at the point of use without the need for additional control cords. Thus, the operator can switch between welding and gouging, for example, with a push of a button with no need to swap leads or disconnect equipment.

The present methods and systems may be realized in hardware, software, and/or a combination of hardware and software. Example implementations include an application specific integrated circuit and/or a programmable control circuit. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A modular welding system having one or more system capabilities, comprising:
a welding power supply;
one or more welding torches;
a wire feeder coupled to one or more of the welding power supply or the one or more welding torches;
a user interface to present the one or more system capabilities; and
control circuitry to:
receive information corresponding to one or more operating parameters from each of the welding power supply, the one or more torches, or the wire feeder,
determine the one or more system capabilities based on the one or more operating parameters; and
enable one or more circuits of the welding power supply, the one or more torches, or the wire feeder corresponding to the one or more system capabilities.

2. The system of claim 1, wherein the control circuitry is further configured to control the user interface to present the determined one or more system capabilities.

3. The system of claim 2, wherein the user interface includes one or more user inputs for selecting the determined one or more system capabilities.

4. The system of claim 1, wherein the one or more operating parameters include one or more of an operating voltage range, an operating current range, a wire feed speed range, or presence of polarity reversing circuitry.

5. The system of claim 1, wherein the one or more system capabilities include one or more of voltage control welding, current control welding, wire feed speed adjustment, or polarity adjustment.

6. The system of claim 1, further comprising one or more sensors to measure one or more characteristics of the welding power supply, the one or more torches, the wire feeder, or the one or more weld cables.

7. The system of claim 6, wherein the one or more sensors are further configured to transmit the measured one or more characteristics to the control circuitry, the control circuitry further configured to calculate a system capability of the one or more system capabilities based on the measurements.

8. The system of claim 6, wherein the one or more sensors include circuitry to determine cable inductance of the one or more weld cables.

9. The system of claim 1, wherein the control circuitry or the user interface is located in the welding power supply.

10. The system of claim 1, wherein the control circuitry or the user interface is located in the wire feeder.

11. The system of claim 1, further comprising one or more auxiliary devices, each auxiliary device including auxiliary control circuitry and communication circuitry to transmit information corresponding to one or more operating parameters to the auxiliary control circuitry.

12. The system of claim 11, wherein the one or more auxiliary devices includes a remote control device or an auxiliary power supply.

13. A wire feeder coupled to one or more of a welding power supply or one or more welding torches, the wire feeder comprising:
a user interface to present one or more system capabilities; and
control circuitry to:
receive information corresponding to one or more operating parameters from each of the welding power supply or the one or more torches;
determine the one or more system capabilities based on the one or more operating parameters; and
control the user interface to present the determined one or more system capabilities.

14. The system of claim 13, wherein the control circuitry is further configured to enable one or more circuits of the welding power supply, the one or more torches, or the wire feeder corresponding to the one or more system capabilities.

15. The system of claim 13, wherein the user interface includes one or more user inputs for selecting the determined one or more system capabilities.

16. The system of claim 13, wherein the one or more system capabilities include a welding type process including one or more of gas metal arc (GMAW) welding, shielded metal arc (SMAW) welding, flux-cored arc (FCAW) welding, gas tungsten arc (GTAW) welding, or gouging.

17. A user interface to present the one or more system capabilities, the user interface comprising:
one or more switches to receive an input corresponding to one or more operating parameters from one or more of a welding power supply, one or more torches, or a wire feeder, and
one or more dynamic displays or icons operable to display the one or more system capabilities corresponding to the one or more operating parameters.

18. The user interface of claim 17, wherein the user interface is incorporated into a wire feeder.

19. The user interface of claim 18, wherein the wire feeder comprises control circuitry operable to enable one or more circuits of the welding power supply, the one or more torches, or the wire feeder corresponding to the one or more system capabilities.

20. The user interface of claim 17, wherein the one or more operating parameters include one or more of an operating voltage range, an operating current range, a wire feed speed range, or presence of polarity reversing circuitry.
